(19) United States
(12) Patent Application Publication
(10) Pub. No.: US 2014/0201227 A1
(43) Pub. Date: Jul. 17, 2014

(54) CONTENT-IDENTIFICATION ENGINE BASED ON SOCIAL MEDIA

(71) Applicant: GETTY IMAGES (US), INC., NEW YORK, NY (US)

(72) Inventors: David Kenneth George Hamilton-Dick, London (GB); Christopher Charles Williams, London (GB); Kaihaan Antony Jamshidi, London (GB); Anthony Edward Galvin, Stewkley (GB)

(21) Appl. No.: 14/156,414

(22) Filed: Jan. 15, 2014

Related U.S. Application Data
(60) Provisional application No. 61/752,864, filed on Jan. 15, 2013.

(51) Int. Cl. G06F 17/30

(52) U.S. Cl. CPC G06F 17/30268
USPC 707/758

(57) ABSTRACT

A system and method for tracking trending topics on social media (e.g., Twitter) associated with a particular event and identifying relevant images or videos that are associated with the trending topic. For example, the system may monitor Twitter feeds associated with a particular sports event and analyze content posted in those feeds. Comments about a particular play made during the sports event (e.g., a touchdown) are detected by the system in the monitored feed content and used to locate and retrieve photos or videos associated with that particular play for display on a website or other content portal.

### CROSS-REFERENCE TO RELATED APPLICATION(S)

This application claims priority to U.S. Provisional Application No. 61/752,864, entitled “CONTENT-IDENTIFICATION ENGINE BASED ON SOCIAL MEDIA,” filed Jan. 15, 2013, the contents of which are incorporated herein in their entirety.

### BACKGROUND

Capturing the attention of consumers on websites or other contents displays is often dependent on finding and selecting eye-catching images relevant to current events. For example, consumers are attracted to the latest pictures of a celebrity at an awards show, replays of a recent scoring play by a sports team, or pictures of the next “must-have” gadget being exhibited at a trade show. Unfortunately, the process for identifying and acquiring relevant images for display is often tedious and time consuming. For example, locating a relevant image associated with a particular current event typically requires manual searching by a user across multiple search engines and image databases. Returned image results are reviewed by the user, and one or more images may be selected by the user and posted to the website in a timely manner. At times, the selection of the most interesting image for display can therefore be dependent on skill, timing, and just plain luck.

A need exists for an improved system and method for providing images in a timely fashion and without requiring extensive manual involvement.

### BRIEF DESCRIPTION OF THE DRAWINGS

FIG. 1 is a diagram of a suitable environment in which a content-identification system may operate.

FIG. 2 is a flowchart of a method for content-identification.

FIG. 3 is a flowchart of a method for setting up keywords for a first example event.

FIG. 4 is a flowchart of a method for listening to catch trending.

FIG. 5 is a graph illustrating simplified results from listening to catch trending where two keyword combination search terms are tracked.

FIG. 6 is a graph illustrating results from listening to catch trending where twenty-five keyword search terms are tracked.

FIG. 7 is a flowchart of a method for utilizing top keyword combination search terms for acquiring images from a database.

FIGS. 8A-8E are flowcharts of methods for addressing specific example conditions that may occur when utilizing top keyword combination search terms for acquiring images from a database.

FIG. 9 is a diagram of a screen display illustrating a series of images posted to a social network website in relation to the first example event.

FIGS. 10A-10C are diagrams of screen displays illustrating individual images posted to the social network website in relation to the first example event.

FIG. 11 is a flowchart of a method for posting an event image roundup in relation to the first example event.

FIG. 12 is a flowchart of a method for setting up keywords for a second example event.

FIG. 13 is a diagram of a screen display illustrating a series of images posted to a social network website in relation to the second example event.

FIGS. 14A-14C are diagrams of screen displays illustrating individual images posted to the social network website in relation to the second example event.

FIG. 15 is a diagram of a screen display illustrating a series of themed boards on a social network website to which images may be posted for a plurality of example events.

FIG. 16 is a diagram illustrating a configuration for dropping images into a short message feed.

### DETAILED DESCRIPTION

A system and method for tracking trending topics on social media (e.g., Twitter) associated with a particular event and identifying relevant images or videos that are associated with the trending topic is provided. For example, the system may monitor Twitter feeds associated with a particular sports event and analyze content posted in those feeds. Comments about a particular play made during the sports event (e.g., a touchdown) are detected by the system in the feed content and used to locate and retrieve photos or videos associated with that particular play for display on a website or other content portal. It will be appreciated that in this manner the system automates curating the most relevant imagery, as well as publishing the imagery in the moment of greatest relevance and interest.

Various embodiments of the invention are described below. The following description provides specific details for a thorough understanding and an enabling description of these embodiments. One skilled in the art will understand, however, that the invention may be practiced without many of these details. In addition, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

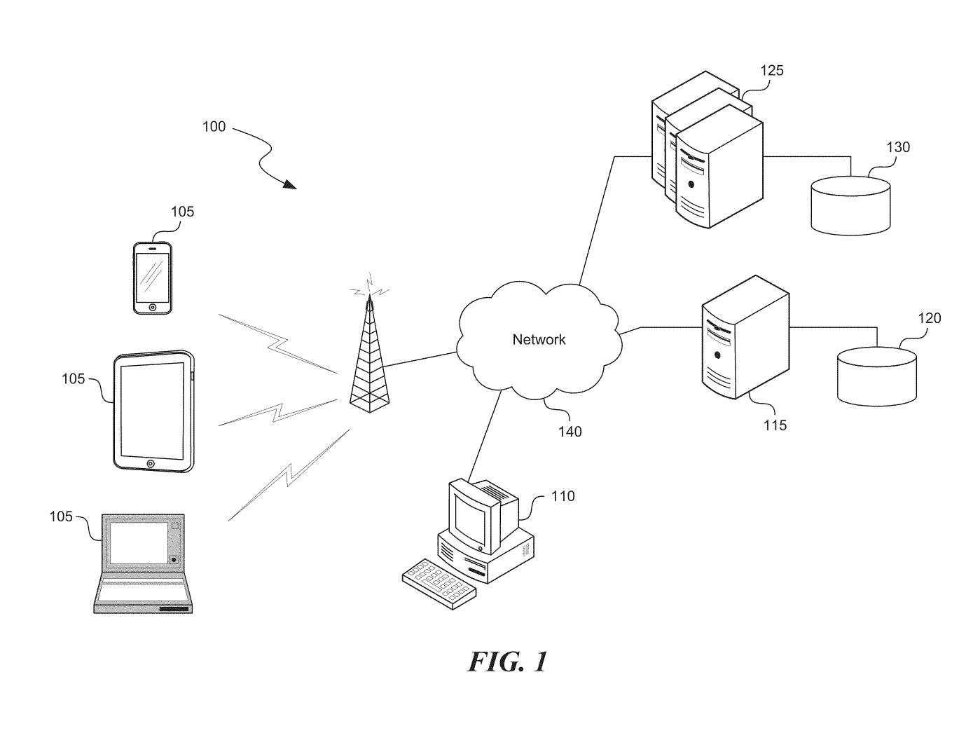

FIG. 1 and the following discussion provide a brief, general description of a suitable computing environment 100 in which a content-identification system can be implemented. Although not required, aspects and implementations of the invention will be described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein.

The terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments such as cloud-based computing environments, where tasks or modules are performed by various remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a content-identification system 100 operates in or among various computing systems, including one or more server computers 115. A data storage area 120 contains data utilized by the content-identification system, and, in some implementations, software necessary to perform functions of the system. For example, the data storage area 120 may contain an organized collection of images or videos and data pertaining to the images or videos to allow images or videos of a certain subject to be identified. As will be described in more detail below, the server 115 typically contains one or more programs for implementing the methods performed by the content-identification system.

The content-identification system 100 communicates with one or more third party servers 125 via public or private networks 140. The third party servers 125 include servers maintained by businesses that periodically provide relevant information to the server 115. For example, some servers make data related to various topics in social media (e.g., Twitter) available to the content-identification system 100. The data may be provided by the third-party servers via an application programming interface (API), via regular transmission of data (using either push or pull techniques), or via other data delivery technique. The content-identification system 100 analyzes the data received from the third party servers 125 and stores all or portions of the received data in data storage areas 120.

Mobile devices 105 and personal computers 110 may be utilized by users for accessing websites, sending messages, sending tweets, etc. The mobile devices 105 and computers 110 communicate with each other, the server 115, and third party servers 125 through public and private networks 140, including, for example, the Internet. The mobile devices 105 communicate wirelessly with a base station or access point using a wireless mobile telephone standard, such as the Global System for Mobile Communications (GSM), Long Term Evolution (LTE), or another wireless standard, such as IEEE 802.11, and the base station or access point communicates with the server 115 and third party servers 125 via the networks 140. Personal computers 110 communicate through the networks 140 using, for example, TCP/IP protocols.

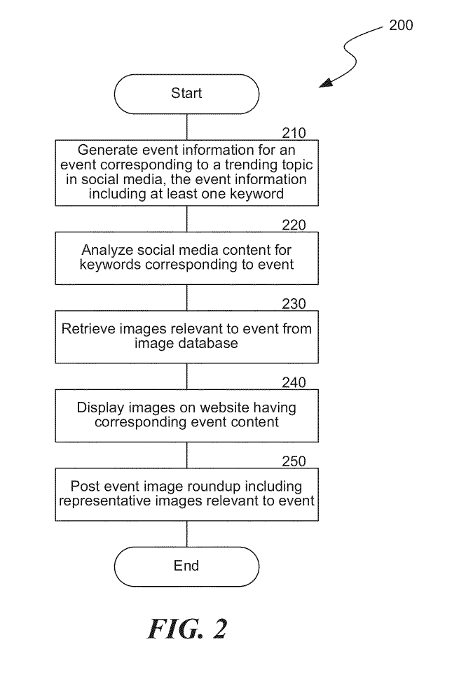

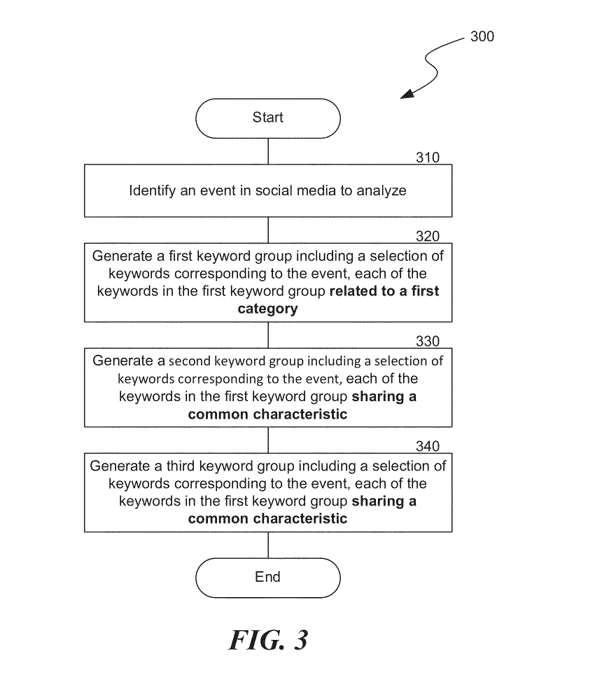

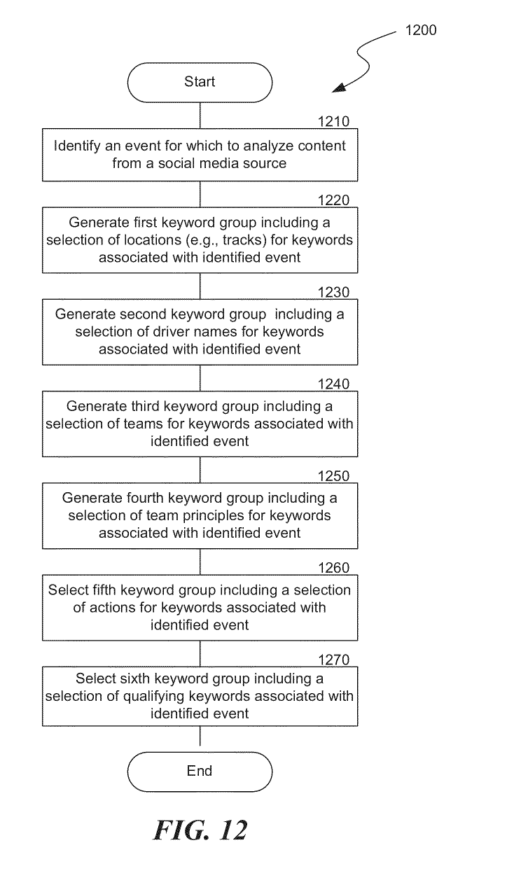

FIG. 2 is a flowchart showing of method 200 for content identification that is implemented by the content-identification system 100. As shown in FIG. 2, at a block 210, event information (e.g., keywords) is set up or generated for an identified event. As will be described in more detail below with respect to FIGS. 3 and 12, the event information includes at least one keyword and may also comprise different groups or categories of keywords in one example implementation. Keywords are terms that describe, characterize, or relate to an event, such as an event identifier, the time of the event, the people involved in the event, the location of the event, actions/verbs characterizing activities at the event, etc. In some embodiments, keywords may be automatically selected or recommended by the system based on an analysis of metadata and/or a narrative associated with an event. For example, the system may select keywords such as goal, kick, celebration, etc. from a description of a World Cup soccer game. The keywords may be associated with the event and stored in the data storage area 120 of FIG. 1 for later comparison to keywords detected in social media content corresponding to the event.

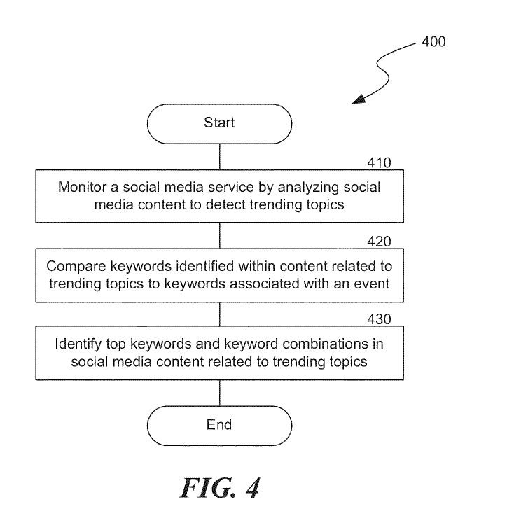

At a block 220, trending topics in social media, such as on Twitter, are monitored and analyzed in order to detect keywords associated with the event. As will be described in more detail below with respect to FIGS. 4-6, an API from a social media service (e.g., Twitter) allows the system to monitor a stream of updates (e.g., tweets) that are being posted to the social media service. The system analyzes the stream of updates and filters the stream by detecting event keywords defined at block 210. In general, the system compiles and counts keywords as they are detected in the social media content. In some embodiments, the keywords that are counted may consist of individual keywords and/or keyword combinations, such as groups of keywords found in social media content being analyzed by the system (e.g., groups of keywords found in individual tweets). Keywords that are detected in abundance within the content being analyzed are referred to as spiking, meaning that the keywords are being posted to the social media service at a rate higher than normal posting rates. Spiking keywords reflect trending topics within the corpus of individuals that are making the posts and within the selection of content being analyzed during a particular period of time.

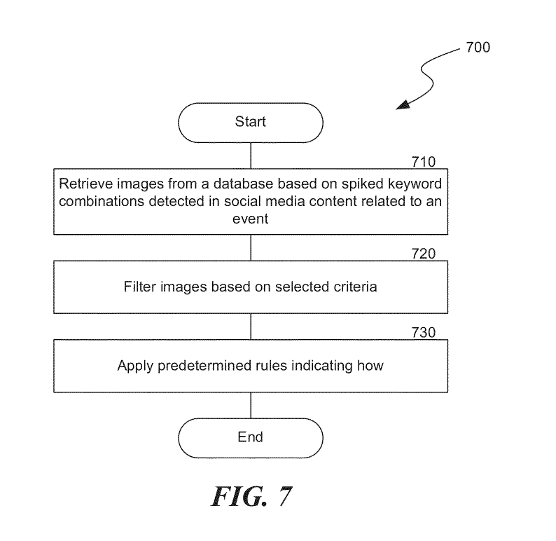

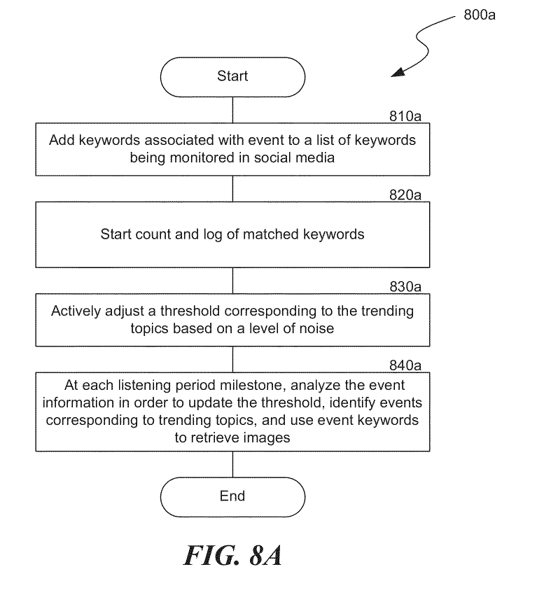

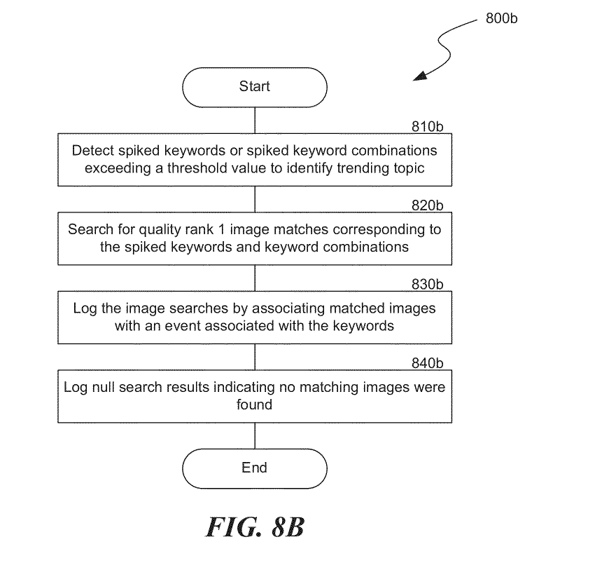

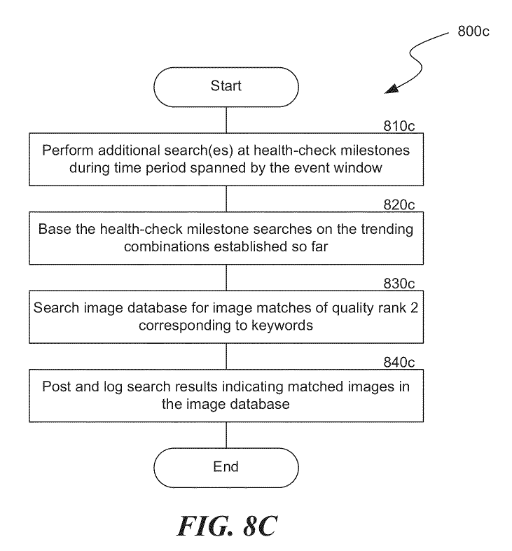

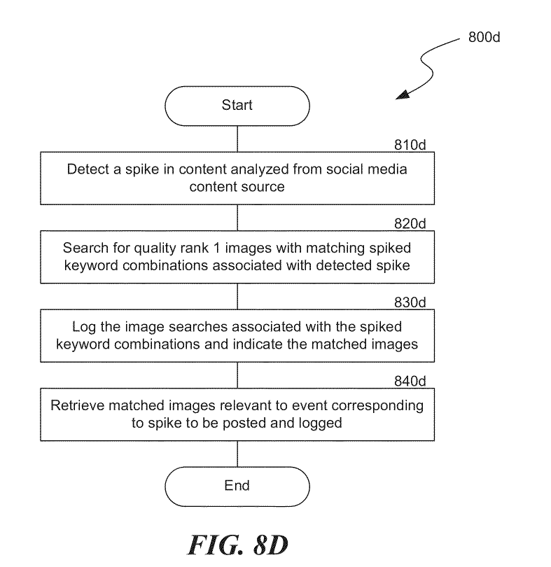

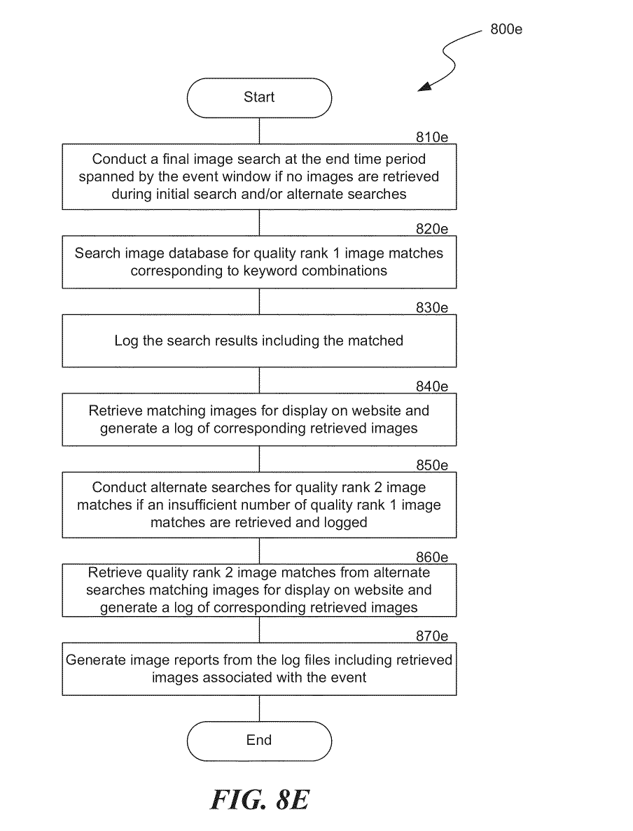

As will be described in more detail below with respect to FIG. 7-8E, spiking keywords detected at block 220 are utilized to locate visual content (e.g., images or videos) associated with the events correlated to those spiking keywords. At a block 230, the system acquires or retrieves visual content from one or more databases based on the detected keywords reflecting the trending topics in social media. The databases may be commercial or non-commercial imagery services, such as Getty Images®, which provides images associated with events. Often, the visual content associated with events are provided by such services in real-time or near real-time, such that that images or videos may be provided to the system in close proximity to the time when then the images or videos were actually captured at the event.

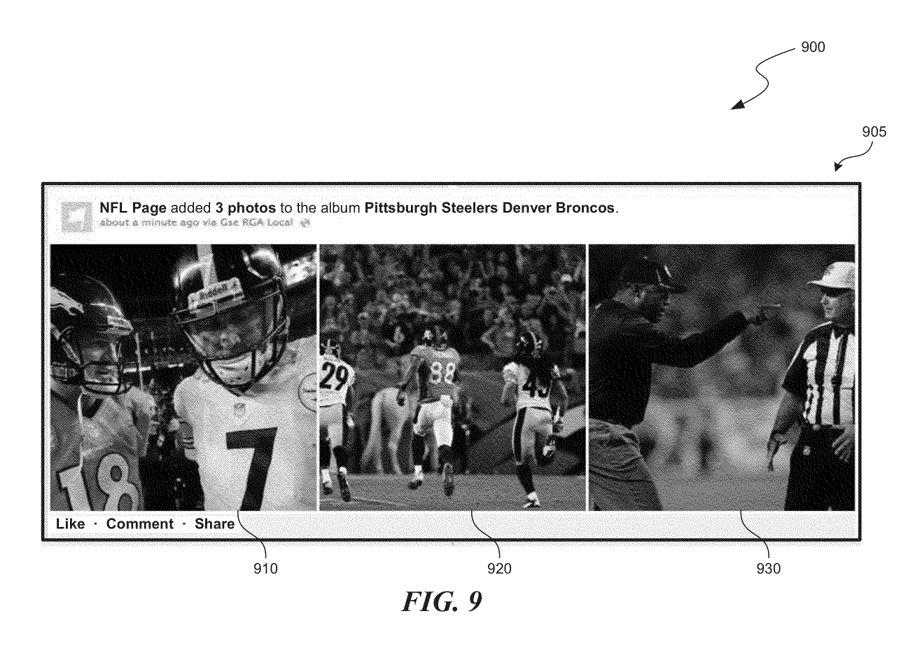

At a block 240, images are provided by the system for display on a website or other content portal. As will be described in more detail below with respect to FIGS. 9-10C and 13-14C, the selected images may be posted to a social network service such as Facebook, etc. or may be used to populate any content site or portal where the display of timely imagery would be beneficial. In certain implementations, metadata associated with the images may be utilized to annotate the images, and/or a short URL may be included where a user can obtain additional information and/or rights to use the image.

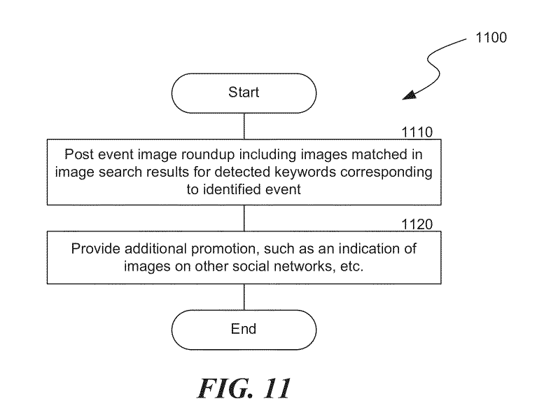

At a block 250, an event image roundup of the images associated with the analyzed event is posted by the system. As will be described in more detail below with respect to FIG. 11, when an event concludes, an event image roundup may be automatically produced that reflects representative images that were associated with the event. For example, once a football game concludes, various images highlighting the game may be posted to a website or other content portal.

FIG. 3 is a flowchart showing a method 300 implemented by the system for generating keywords for a first example event. At a block 310, an event is identified by a user or by the system to be tracked. For example, the user may identify an event such as the Steelers vs. Broncos game on the 9th of Sep., 2012. At a block 320, a first keyword group is selected by the user or by the system. The user may manually enter a number of keywords that broadly characterize the specific event. Alternatively or additionally, the system may automatically generate a number of keywords from the metadata associated with the event and/or from data mining through the network. For example, the keywords selected for the first keyword group may include the names of the teams playing in the event, such as the Pittsburgh Steelers and Denver Broncos, or broader terms associated with the event, such as Sunday Night Football. The first keyword group may also include keywords that have common characteristics, such as names of teams, or time periods, etc., in some embodiments.

At a block 330, a second keyword group may be selected by the user or by the system. The second group of keywords may include keywords that are broadly applicable across both the identified event and other similar events. For example, the second set of keyword might include actions, time periods, etc. within a football game such as “touchdown,” “fourth quarter,” “last minute,” etc. The system may build recommendations for the second group of keywords by maintaining a database of past events and the keywords used to describe those events. The keywords from past events can be mined by the system to identify commonly-used keywords that occur across similar events. For example, keywords such as “touchdown” and “tackle” may be commonly used when the word “football” or “NFL” is used to describe an event. The second keyword group can also include keywords related to a specific category or sharing a common characteristic.

At a block 340, a third keyword group may be selected by a user or by the system. The third keyword group may characterize the participants in the event. For example, the third keyword group may include the names of the individual players for each of the football teams, such as Adams, Allen, Batch, etc. The third keyword group may be derived from public databases associated with the participants in the event, such as team rosters. The third keyword group may similarly include a categorized group of keywords or may include various keywords that are less relevant to the event, but are still helpful to detect the event in content from social media.

It will be appreciated that the user may enter each keyword group, the system may automatically select each keyword group, the system may recommend keywords to the user that are then confirmed by the user, or any combination thereof. Although the method 300 shows three keyword groups being selected for use in monitoring an event, a greater or lesser number of keyword groups may be used by the system.

FIG. 4 is a flowchart showing a method 400 for listening to or monitoring a social media source in order to catch or detect trending topics (e.g., tracking trending topics on social media, such as Twitter). At a block 410, a social media service is monitored by the system in order to detect trending topics in social media (e.g., Twitter). The monitoring includes analyzing content available through the social media service and detecting keywords repeated within that content. The content from the social media source may be directly provided by the social media service or may be publicly accessible via the Internet. At a block 420, terms from identified trending topics are compared by the system to keywords that have been selected for the event (e.g., as described in FIG. 3).

At a block 430, the system identifies the top keywords that are contained in the trending topics. The top keywords can include the most relevant keywords relating to a particular topic or event. For example, individual tweets from Twitter may be analyzed to determine what combinations of previously-selected keywords are contained in each tweet, with a count being kept of the most often found or commonly used keyword combinations (e.g., Steelers Broncos Peyton; Denver Broncos Peyton; Pittsburgh Steelers Denver Broncos, etc).

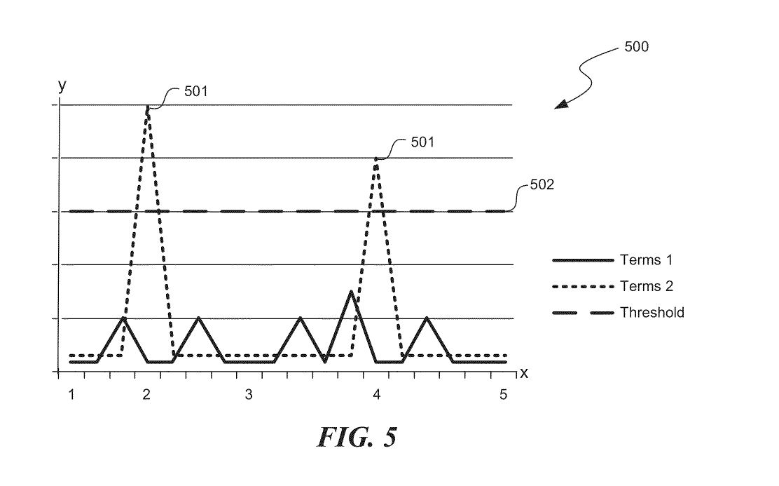

FIG. 5 is a graph 500 illustrating simplified results generated by analyzing content from a social media source to identify trending topics. In the graph 500, two keyword combinations are being tracked. “Terms 1” and “Terms 2” each represent different combinations of keywords that match terms being used or posted through a social media service. For example, the graph 500 reflects the frequency that keywords being tracked by the system are being used in tweets from various users. The height of the keyword spikes 501 demonstrates the volume of tweets (e.g., the number count) that include each keyword combination during the designated time periods being analyzed. The time period being analyzed is indicated on the x-axis (e.g., every 5 minutes).

For keyword spikes 501 that exceed a threshold 502, the corresponding keyword combination is deemed to reflect a commonly discussed, e.g., popular or “hot” topic. As a result, the spiking keyword combinations may be utilized to retrieve and select images to post to a website. Since the spiking keyword combinations represent topics of immediate interest to a population of consumers, images selected using the spiking keyword combinations are likely to be of significant interest to those consumers as well as any other consumers interested in the event. Various specific examples of how images may be selected relative to the spiking keyword combinations as well as the time periods indicated on the x-axis are described in more detail below with respect to FIGS. 8A-8E.

In some embodiments, when multiple events occur simultaneously, the system may analyze content from social media sources for various keywords in order to identify trending topics associated with each of the events. In such instances, various mechanisms may be utilized by the system to equally allocate the number of images posted for each of the events. For example, an equal number or file size of images or video may be posted for each of the events being monitored or a number of images posted may be determined based on the popularity of each event. In some embodiments, when multiple events being monitored occur simultaneously, the system may also analyze the social media content to detect and identify trending topics that are associated with the combination of events. For example, the system may identify spiked keyword combinations corresponding to the collective social media content associated with two events (e.g., to identify trending topics based on the collected tweets from two events).

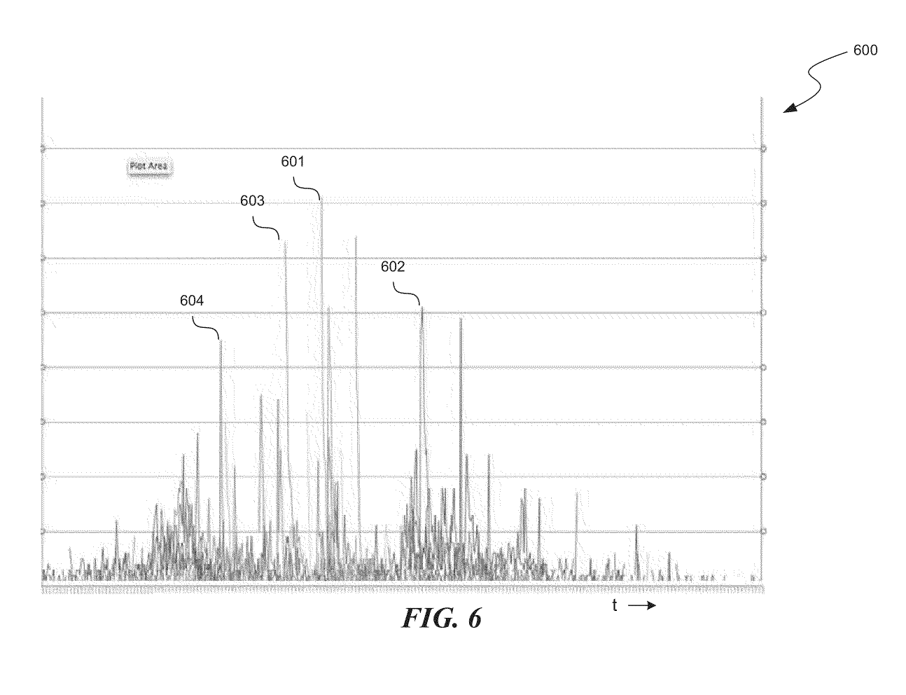

FIG. 6 is a graph 600 illustrating results from analyzing content from social media services in order to detect trending topics where twenty-five keyword combinations are being tracked. As illustrated in FIG. 6, over the time period of the event, multiple spikes (e.g., 601, 602, 603, 604) occur indicating different spiked keyword combinations. As will be described in more detail below with respect to FIG. 7, the top keyword combinations may be utilized for selecting images that will be posted to a website. The top keyword combinations may include the spiked keyword combinations having the highest spike and/or a spike exceeding a particular threshold value. The top keyword combinations indicate the most relevant keywords used to identify an event or combination of events, such as the most popular topic being tweeted about on Twitter.

FIG. 7 is a flowchart of a method 700 for utilizing top keyword combinations for identifying images from a database to be posed to a website or other content portal. The images may be retrieved from a database and posted to a website having content related to the topic (e.g., event) identified. At a block 710, images are selected by the system from a database by searching the database using the spiked keyword combinations (e.g., keyword combinations such as Steelers, Broncos, Peyton; Steelers, touchdown pass; touchdown pass, Peyton, etc.). The database contains images and/or videos that have been characterized by keywords, category, narrative, etc. such that the images or videos are capable of being searched by keyword. For example, the database may be constructed as described in U.S. Pat. No. 6,735,583, entitled “Method and System for Classifying and Locating Media Content,” which is incorporated herein by reference in its entirety. At a block 720, the images are filtered by the system based on selected criteria. The selected criteria may include criteria based on time (e.g., most recent images), relevancy (e.g., highest ranking on editor's picks, highest ranking based on voting by viewers, etc.) or based on image size, image metadata, previous usage of the images, etc.

At block 730, the system applies additional rules, such as to never post a duplicate image. The rules can be predetermined by a user of the system or by a third party content provider sourcing the images for the system. The rules may additionally include not posting images over or under a certain file size or image size.

In some embodiments, when a spiked keyword combination exceeds a certain threshold, the system automatically searches a database for images associated with the keyword combination. The search may rank images based on various parameters, such as keyword weights, keyword confidence, image quality rank, etc. An image quality rank may be an indicator of editorial quality. For example, images of “quality rank 1” may be those deemed by an editorial team to be images of the very highest quality. For example, a high quality rank may be based on prominence, composition, scope, persons, etc. Images of “quality rank 2” may still be of relatively high quality, while images of “quality rank 3” may be of successively lower quality. The ranking of the images may dictate the order in which the system retrieves the images for use. In some embodiments, additional limitations may be imposed on the use of images based on the quality of the ranking For example, if an image of high quality rank 1 is only allowed to be posted once a day and is retrieved for two events, the first based on a keyword combination barely reaching a specified threshold value and the second for a keyword combination that greatly exceeds the threshold value, the retrieved image will be used for the second keyword combination.

In some circumstances, the system may not identify sufficient quality rank 1 images to select for display. In those circumstances, there may be a number of fallbacks for the system to ensure that relevant images are located and posted. In one implementation, the first fallback involves giving trended keyword combinations a second chance if they fail to match images the first time around. In other words, if a search for images that are associated with a particular keyword combination fails to locate any quality rank 1 images, the system may wait for a short period and then search again for matching images that are quality rank 1. For example, if an event has an associated period of time during which social media feeds are being monitored (hereinafter the “event window), then the system may wait for a period (e.g., equal to 2%, 5%, 10%, etc. of the event window) before re-searching for images matching the keyword combinations. The intervening period allows for event images or videos to be uploaded to the database and appropriately characterized, such as might occur during a live event when there may be a slight lag between the time when an image is taken and the time that it is made available in a searchable database.

A second fallback that may be utilized by the system includes monitoring the event at specific points (e.g., at the halfway point of the event) and performing an additional check to see if there are images that match the trending topics. If there are still no rank 1 images posted to the database, the system may instead use the event's trending topics and search for images in the database that have a matching quality rank 2. At the end of the event window, a final search may be conducted, first for images matching quality rank 1, and if an insufficient number of images of quality rank 1 are found, then for quality rank 2.

In some implementations, milestones are utilized that are specific points in time in the event that trigger searches of the image database by the system. There may be two types of milestones, namely regular listening period milestones and health-check milestones. In regular listening period milestones, the current social media data is analyzed for trending topics. These regular listening period milestones may be designated to occur, for example, at every 5% of the event window. In health-check milestones, the focus is on checking whether the regular listening milestones are generating a sufficient number of trending topics and images associated with those trending topics. In one implementation, the health-check milestones involve checking the volume of social data monitored by the system and the number of images being posted by the system as a result of the monitored social data. In one specific example embodiment, these health-check milestones may occur at 25%, 50%, 75%, and 100% of the event window.

In general, a spike in a keyword combination that is indicative of a trending topic may be defined as a percentage increase in the number of tweets for those keywords. As an example, during a first time period there may be 100 tweets containing the words “Steelers” and “Broncos”. Then, during a second time period (e.g., 5 minutes later) there may be 200 tweets containing the words “Steelers” and “Broncos.” A comparison of the number of tweets during the two time periods reflects a percentage increase of 100% in tweets. Such an increase in tweets may reflect a spike reflecting a trending topic, provided that the 100% exceeds a threshold that is set by the system. Thus, in certain implementations, percentage increases are utilized to determine when interest is being generated and people are starting to talk about a particular aspect in an event that has just occurred.

In some embodiments, the keyword spikes indicative of trending topics are analyzed to determine which spikes will be utilized for selecting images. When social data is being analyzed for a specific time period, a list of trending topics is usually generated by the system for the specific time period. To choose which of the trending topics to utilize, statistics about the trending topics are analyzed by the system. Statistics related to the time period during which the trending topics were identified include: the number of tweets matching all the trending topics in the time period; and the average number of tweets in the time period. The system may use these statistics to calculate a threshold for trending topics based on the number of matching tweets in the time period. Statistics relating to the detected trending topics include: the number of tweets matching the trending topic for the time period; and the percentage change from the last time period. Once the statistical data is compiled, the trending topics are sorted by their percentage changes so that the largest increases are at the top of the list. Then, in one implementation, all of the new trending topics may be filtered out. New trending topics are filtered out since it is beneficial for a trending topic to be identified in at least two periods before being utilized by the system. Trending topics that matched below the current threshold, including trending topics having percentage decreases, may also be filtered out. In one specific example implementation, out of a list of 20-30 trending topics that are identified during a check of social media feeds, only 3-4 topics may be left after filtration. An image database, such as a commercial image service provided by Getty Images® or a non-commercial service provided by Google® images is searched by the system utilizing these trending topics.

FIGS. 8A-8E are flowcharts showing methods performed by the system for addressing specific example conditions that may occur when utilizing keyword combination as search terms for acquiring images from a database. FIG. 8A is a flowchart illustrating a method 800A that may be performed by the system at the start of an event (e.g., at time period 1 in FIG. 5). At a block 810A, the event's keywords are added to the list of keywords that are being monitored by the system. At a block 820A, the system begins logging of matching tweets (e.g.: 120 matches for Steelers, Broncos, Touchdown; 100 matches for Steelers, Touchdown, Pass; 20 matches for Broncos, Touchdown, etc). At a block 830A, the threshold used to assess whether a topic is a trending topic is actively adjusted by the system based on the level of noise. In one specific example embodiment, the adjustment of the trending threshold based on the level of noise includes determining a running average of the number of tweets being monitored, with the threshold being set at a selected level above the running average. At a block 840A, the system analyzes the event data at each listening period milestone, updates the threshold, identifies trending topics, and uses the trending topic keywords to search for images within a database.

FIG. 8B is a flowchart illustrating a method 800B performed by the system for dealing with a spike where no images corresponding to the spiking keywords are contained within an imagery database (e.g., at time period 2 in FIG. 5). At a block 810B, a spike is detected by the system (i.e., the number of matching tweets goes over the threshold). At a block 820B, the system conducts a search for quality rank 1 images with the matching keyword combinations. At a block 830B, the searches are logged by the system. At a block 840B, if no matching images have been detected, the fact that no matching images were found is logged.

FIG. 8C is a flowchart illustrating a method 800C performed by the system for addressing a circumstance where no topics are trending and no images would otherwise be identified by the system (e.g., at time period 3 in FIG. 5). At a block 810C, an additional search is performed at health-check milestones during the event (e.g., at 25%, 50%, 75% and 100% of the event time window). At a block 820C, the health-check milestone searches are based on the trending combinations established so far. At a block 830C, a search is performed by the system for images of quality rank 2. At a block 840C, when matching images are found by the system, they are posted to a website or other content recipient and logged.

FIG. 8D is a flowchart illustrating a method 800D performed by the system for addressing a circumstance where a spike occurs and when images are identified in a database based on the spiking keywords (e.g., at time period 4 in FIG. 5). At a block 810D, a spike is detected by the system (i.e., the number of matching tweets goes over the threshold). At a block 820D, a search is performed by the system for quality rank 1 images. At a block 830D, the searches are logged by the system. At a block 840D, the quality rank 1 images are provided by the system for posting to a website or other content recipient and logged.

FIG. 8E is a flowchart illustrating a method 800E that may be performed by the system if no images have been identified in a database even though the end of an event has been reached (e.g., at time period 5 in FIG. 5). At a block 810E, if no images were identified from the primary search or fallback searches, a final search is conducted by the system at the end time of the event window. At a block 820E, a search is performed by the system for quality rank 1 images with matching combinations. At a block 830E, the searches are logged by the system. At a block 840E, any matching quality rank 1 images are provided by the system for posting to a website or other content recipient and logged. At a block 850E, if an insufficient number of quality rank 1 images are found, a fallback search is conducted for matching quality rank 2 images. At a block 860E, any matching quality rank 2 images are provided by the system for posting to a website or other content recipient and logged. At a block 870E, the system creates reports from the log files.

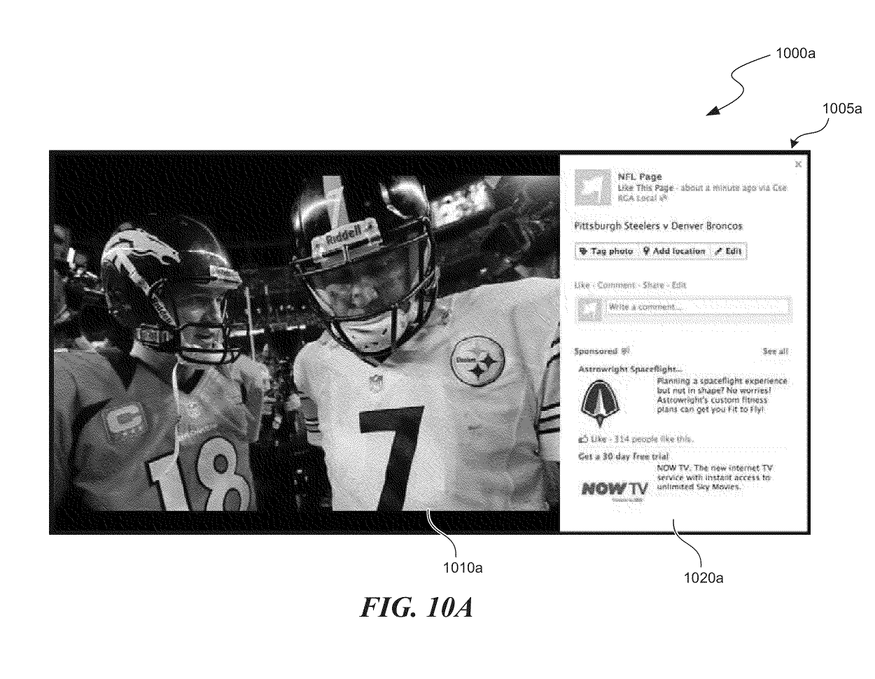

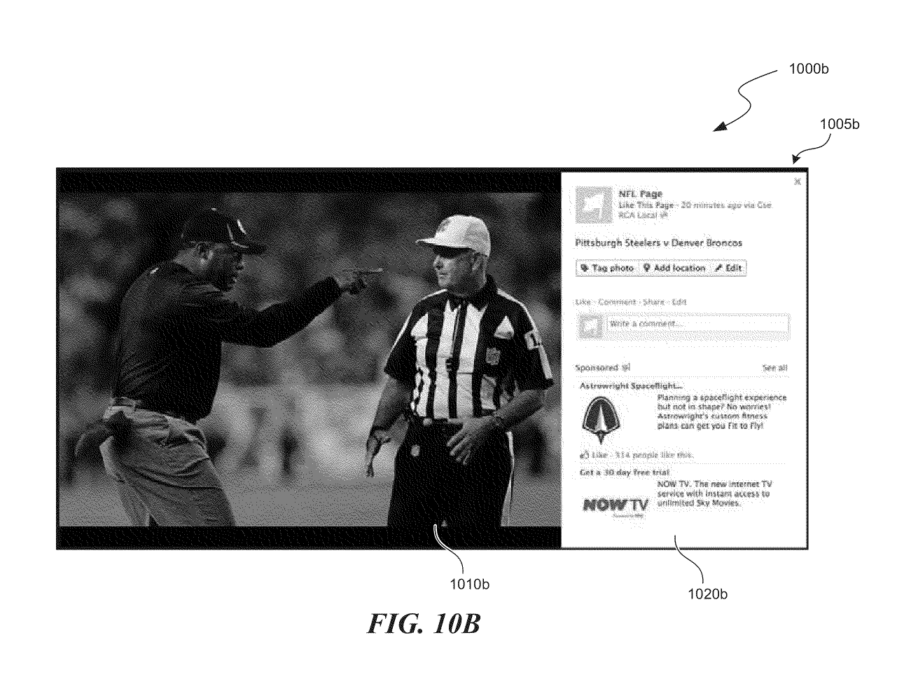

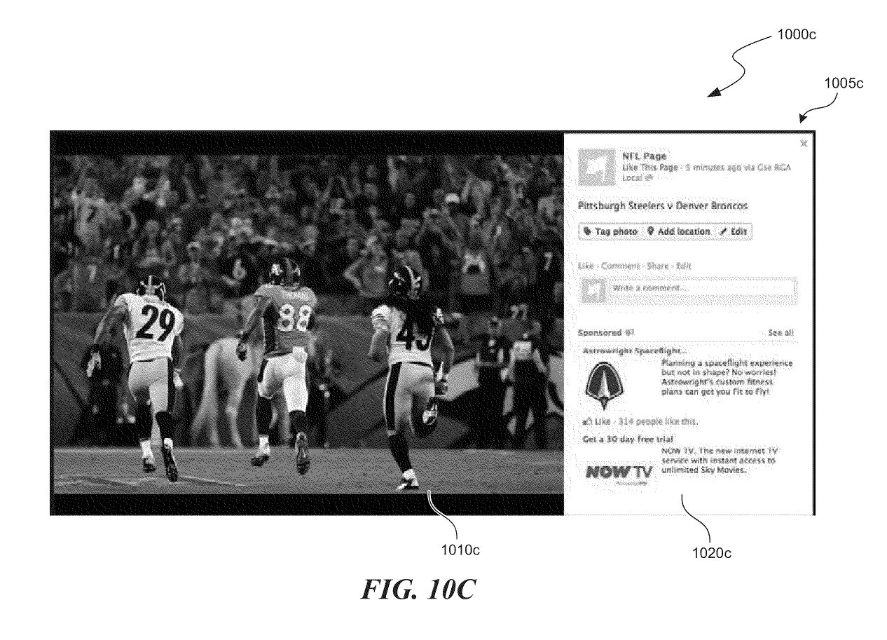

FIG. 9 is a diagram of a screen display 900 illustrating a series of images that may be posted to a social network website in relation to the first example event. The series of images may be provided in a window 905, along with a summary of the images (e.g., “NFL page added three photos to the album Pittsburgh Steelers Denver Broncos”). The series of images may include individual images 910, 920 and 930, as will be described in more detail below with respect to FIGS. 10A-10C.

FIGS. 10A-10C are diagrams of screen displays 1000a-1000c illustrating individual images posted to a social network website in relation to the first example event. In each of the screen displays 1000a-1000c, a window 1005a-1005c includes a respective individual image 1010a-1010c and a respective additional window area 1020a-1020c. The individual images 1010a-1010c may comprise larger versions of the same images 910-930 illustrated in FIG. 9. The additional window areas 1020a-1020c may include additional information, such as summaries, comments, advertisements, etc.

FIG. 11 is a flowchart 1100 showing a method performed by the system for posting an event image roundup in relation to the first example event. As shown in FIG. 11, at a block 1110, an event image roundup is posted (e.g., GettyTrending@GettyTrending; Steelers v Broncos match gallery: fb.me/2hD7c9J #nfl #peyton, etc.). At a block 1120, additional promotion is provided, such as an indication of images on other social networks, etc.

FIG. 12 is a flowchart 1200 showing a method facilitated by the system for setting up keywords for a second example event. It will be appreciated that the setting up of the keywords for the second example event in FIG. 12 is similar to the setting up of the keywords for the first example event of FIG. 3. As shown in FIG. 12, at a block 1210, an event is identified (e.g., Monza, 10th Sep., 2012). At a block 1220, a first keyword group is selected by a user or by the system (e.g., the name of the track, such as Monza, Ascari, Parabolica, Della Roggia, etc.). At a block 1230, a second keyword group is selected by a user or by the system (e.g., the names of the drivers, such as Sebastian Vettel, Mark Webber, Lewis Hamilton, etc.). At a block 1240, a third keyword group is selected by a user or by the system (e.g., the names of the driving teams, such as Red Bull, McLaren, Ferrari, Mercedes, etc.). At a block 1250, a fourth keyword group is selected by a user or by the system (e.g., the names of the team principals, such as Christian Horner, Martin Whitmarsh, Eric Boullier, etc.). At a block 1260, a fifth keyword group is selected by a user or by the system (e.g., actions or other terms that may occur during the race, such as crash, collision, overtake, off, steward's inquiry, drive-through, penalty, etc.). At a block 1270, a sixth keyword group is selected by a user or by the system (e.g., additional race terms for qualifying, such as pole, Q1, Q2, Q3, etc.).

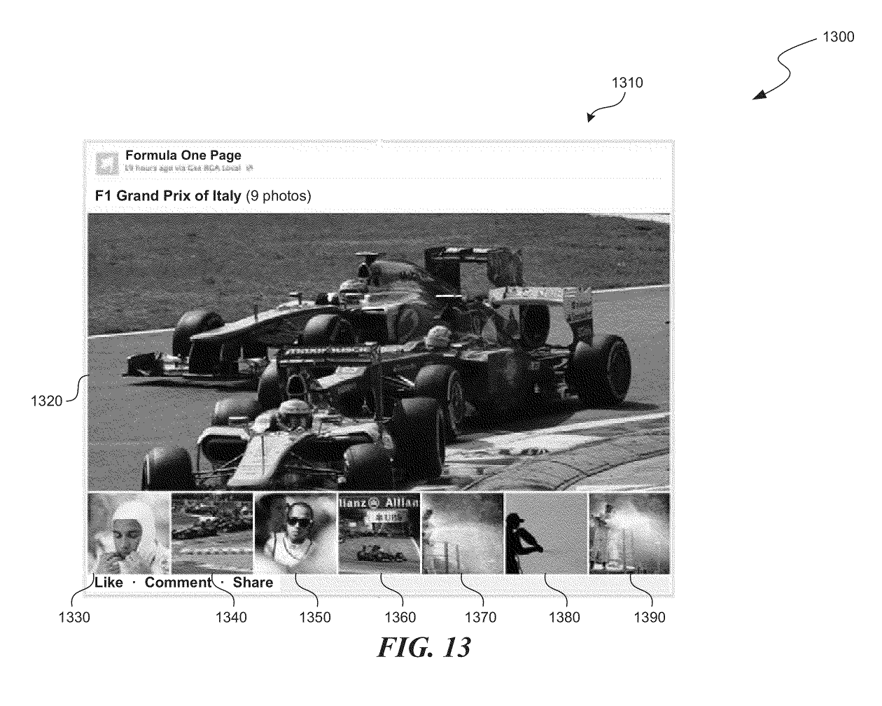

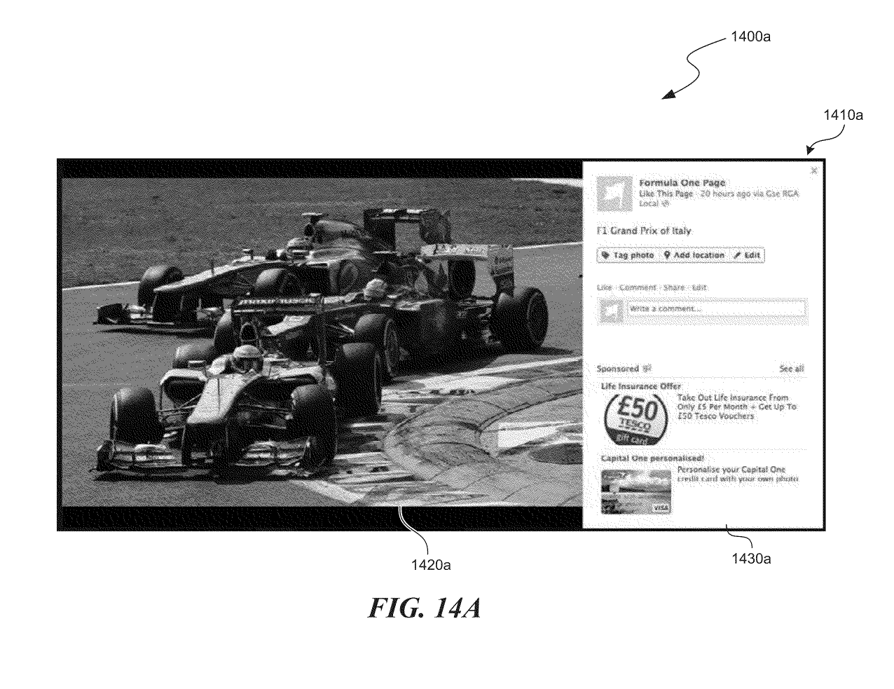

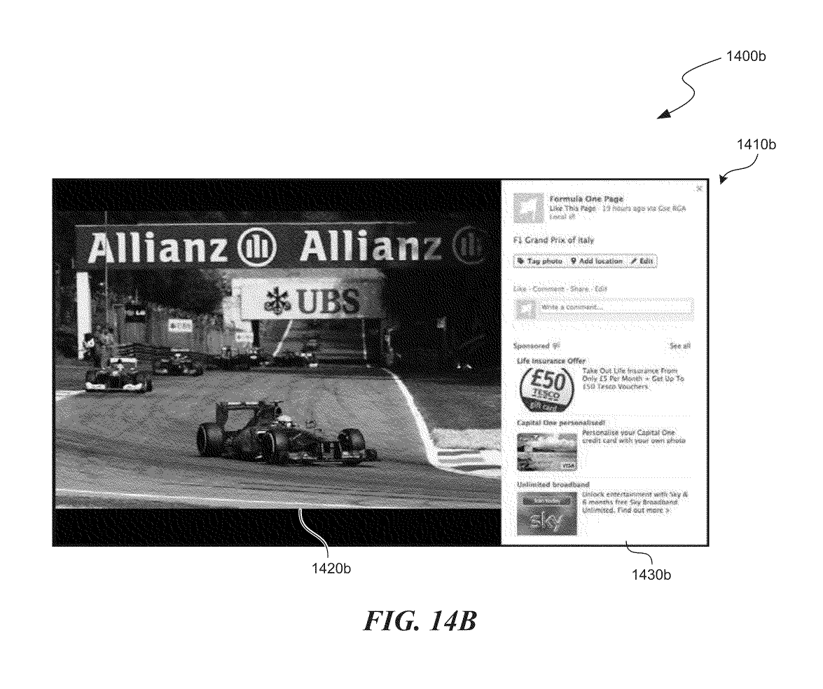

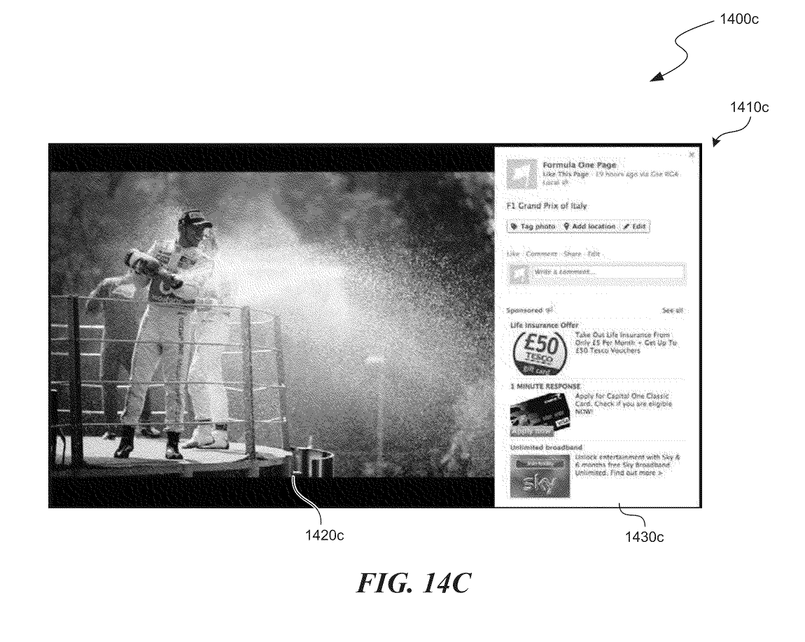

FIG. 13 is a diagram of a screen display 1300 illustrating a series of images that may be posted to a social network website in relation to the second example event. It will be appreciated that the images to be posted may be selected according to a process similar to that described above with respect to FIGS. 2-8E for the first example event. As shown in FIG. 13, a window 1310 includes the series of images, and may also provide summary information (e.g., “Formula One Page: F1 Grand Prix of Italy—9 photos”). A first image 1320 of the series of images is illustrated in a relatively enlarged format, while the remaining images 1330-1390 in the series are shown as smaller thumbnails which may be selected, as will be described in more detail below with respect to FIGS. 14A-14C.

FIGS. 14A-14C are diagrams of screen displays 1400a-1400c illustrating individual images posted to a social network website in relation to the second example event. As shown in FIGS. 14a-14c, windows 1410a-1410c are provided which include the individual images 1420a-1420c, as well as additional window areas 1430a-1430c. The images 1420a, 1420b and 1420c correspond to the images 1300, 1360 and 1390, as selected from the series of images of FIG. 13. The additional window areas 1430a-1430c may include additional information (e.g., summaries regarding the event or images, comments, sponsors' advertisements, etc.).

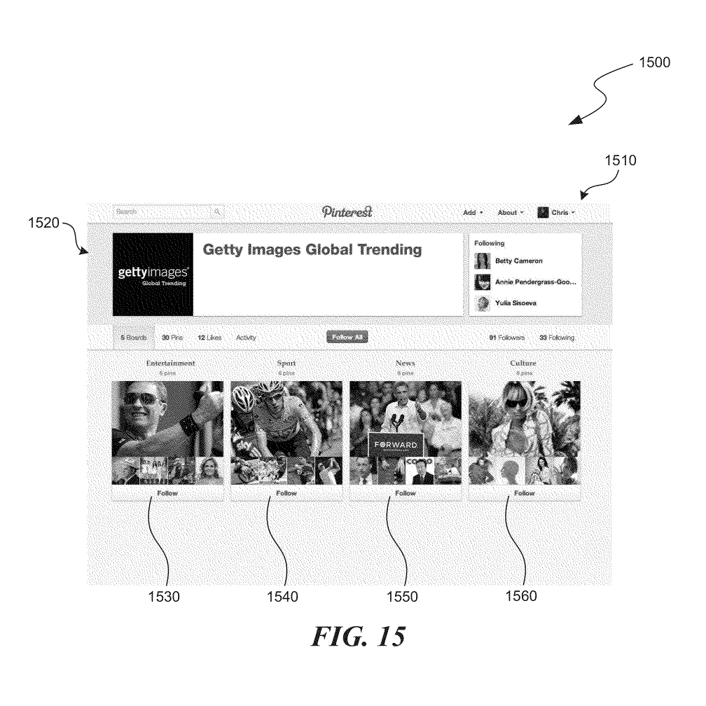

FIG. 15 is a diagram of a screen display 1500 illustrating a series of themed boards on a social network website to which images may be posted for a plurality of example events. As shown in FIG. 15, a window 1510 includes a window area 1520 and themed image boards 1530, 1540, 1550 and 1560. The window area 1520 may indicate information regarding the website on a social network (e.g., Pinterest). The themed image boards 1530-1560 may in certain implementations include images for various categories and/or example events (e.g., entertainment, sports, news, culture, etc.). It will be appreciated that the images posted to each of the various image boards 1530-1560 may be selected according to a process similar to that described above with respect to FIGS. 2-8E.

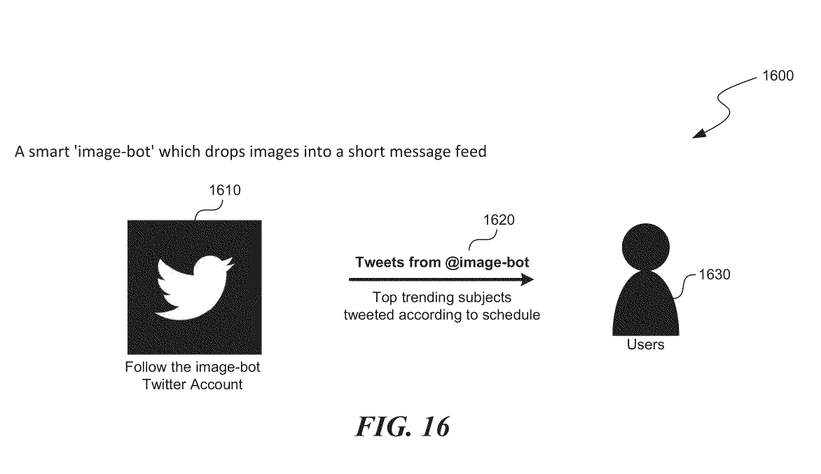

FIG. 16 is a diagram 1600 illustrating how images may be dropped into a short message feed (e.g., for Twitter). As shown in FIG. 16, an image-bot 1610 that utilizes a Twitter account sends tweets 1620 to users 1630. In one embodiment, the tweets 1620 are provided regarding top trending subjects, which are tweeted according to a specified schedule (e.g., tweeted hourly, daily, up to a maximum number of tweets per day, etc.). The image-bot 1610 drops images into the tweets 1620. The image-bot 1610 selects such images using a process similar to that described above with respect to FIGS. 2-8E.

From the foregoing, it will be appreciated that specific embodiments of the invention have been described herein for purposes of illustration, but that various modifications may be made without deviating from the scope of the invention. For example, those skilled in the art will appreciate that the depicted flow charts may be altered in a variety of ways. More specifically, the order of the steps may be re-arranged, steps may be performed in parallel, steps may be omitted, other steps may be included, etc. Accordingly, the invention is not limited except as by the appended claims.

1. A method implemented by a computing system to select image files relevant to an event for display, the method comprising:
retrieving a plurality of keywords associated with an event;
monitoring content provided by a social media service to identify trending topics, the trending topics identified by:
analyzing the content provided by the social media service to detect the presence of one or more of the retrieved plurality of keywords in the content;
maintaining a measure of the detected presence of one or more of the plurality of keywords in the content; and
identifying a trending topic when the measured presence exceeds a threshold, the identified trending topic having associated keywords;
using keywords associated with identified trending topics to select one or more image files corresponding to the event; and
providing the one or more selected image files for display.

2. The method of claim 1, wherein the image file represents a static image or video.

3. The method of claim 1, wherein the retrieved plurality of keywords are selected from the group consisting of an event identifier, a time of the event, people involved with the event, a location of the event, or activities related to the event.

4. The method of claim 1, wherein the measure of the detected presence includes a count of the one or more of the retrieved plurality of keywords in the content.

5. The method of claim 4, wherein the measure of the detected presence includes a percent increase or decrease in the one or more of the plurality of keywords in the content.

6. The method of claim 1, wherein the plurality of keywords are provided by a user.

7. The method of claim 1, wherein the plurality of keywords are generated by:
analyzing metadata associated with the event; and
selecting the plurality of keywords from the analyzed metadata based on frequency of keyword occurrence in the metadata.

8. The method of claim 1, wherein the one or more image files are further selected based on any one or more of a predetermined quality assessment of the image file, creation time of the image file, image size, image type, or previous usage of the image file.

9. The method of claim 1, wherein the image files are selected at periodic intervals throughout a specified time period associated with the event.

10. The method of claim 1, wherein the image files are selected during the event at a rate that depends on a number of image files corresponding to the event and available for selection.

11. A method implemented by a computing system to display image files relevant to an event, the method comprising:
retrieving a plurality of keywords associated with an event;
monitoring content provided by a social media service to identify trending topics during the event, the trending topics identified by:
analyzing the content provided by the social media service to detect the presence of one or more of the retrieved plurality of keywords in the content;
maintaining a measure of the detected presence of one or more of the plurality of keywords in the content; and
identifying a trending topic when the measured presence exceeds a threshold, the identified trending topic having associated keywords;
using keywords that are associated with the identified trending topics to select one or more image files corresponding to the event;
displaying selected image files associated with trending topics during the event; and
displaying a set of the selected image files associated with trending topics at the end of the event.

12. The method of claim 11, wherein the measure of the detected presence includes a count of the one or more of the plurality of keywords in the content.

13. The method of claim 12, wherein each image file in the set of the selected image files is selected based on an amount that the measured presence of the corresponding trending topic exceeded the threshold.

14. The method of claim 12, further comprising:
generating a list of trending topics identified during the event; and
determining position of each of the identified trending topic on the list based on the measure of the detected presence during the event.

15. The method of claim 14, further comprising filtering the list of trending topics based on the position in the list and removing trending topics positioned lower on the list.

16. The method of claim 14, wherein the top trending topics on the list correspond to the selected image files displayed during the event.

17. The method of claim 11, further comprising: searching a database of image files for the one or more image files based on matched keywords during the event.

18. The method of claim 17, wherein the database is searched at predetermined intervals during the event.

19. The method of claim 17, wherein, if no images files are matched, the method further comprises selecting one or more image files having lower match quality.

20. A non-transitory computer-readable medium encoded with instructions executable by a processor for performing a method for providing image files relevant to an event, the method comprising:
retrieving a plurality of keywords associated with an event;
monitoring content provided by a social media service to identify trending topics, the trending topics identified by:
analyzing the content provided by the social media service to detect the presence of one or more of the received plurality of keywords in the content;
maintaining a measure of the detected presence of one or more of the plurality of keywords in the content; and
identifying a trending topic when the measured presence exceeds a threshold, the identified trending topic having associated keywords;
using keywords that are associated with trending topics to select one or more image files corresponding to the event; and
providing the one or more selected image files for display.

21. The non-transitory computer-readable medium of claim 20, the method further comprising:
identifying trending topics during the event; and
displaying the selected image files associated with trending topics during the event.

22. The non-transitory computer-readable medium of claim 20, wherein the measure of the detected presence includes a count of the one or more of the plurality of keywords in the content.

23. The non-transitory computer-readable medium of claim 20, wherein the measure of the detected presence includes a percent increase or decrease in the one or more of the plurality of keywords in the content.

24. The non-transitory computer-readable medium of claim 20, wherein the image file represents a static image or video.
